(19) United States
(12) Patent Application Publication
(10) Pub. No.: US 2006/0200737 A1
(43) Pub. Date: Sep. 7, 2006

(54) Image display device, image display system, and a program for executing an image displaying method by a computer

(75) Inventor: Yasuhito Nagatomo, Hino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/342,922

(22) Filed: Jan. 30, 2006

(30) Foreign Application Priority Data
Mar. 1, 2005 (JP) 2005-055428
Mar. 23, 2005 (JP) 2005-083386

(51) Int. Cl. G06F 17/21

(52) U.S. Cl. 715/500

(57) ABSTRACT

An image display device for displaying a document containing a text and a graphic chart relevant to the text on a display screen includes a document relevance determination section for determining the relevance between the text and the graphic chart contained in the document by analyzing the document, and a display timing control section for controlling the display start and end on the display screen for the graphic chart contained in the document, based on a display state on the display screen for the text determined to be relevant to the graphic chart by the document relevance determination section.

The entire disclosure of Japanese Patent Application Nos. 2005-55428 and 2005-83386, filed Mar. 1, 2005 and Mar. 23, 2005, respectively are expressly incorporated by reference herein.

### BACKGROUND

1. Field of the Invention

The present invention relates to an image display device, a program for executing an image displaying method for use with the image display device by a computer, and an image display system, and more particularly to an image display device for displaying a text, and a figure, a table, a graph or the like (graphic chart) relevant to the text, an image display system, and a program for executing an image displaying method by a computer.

2. Description of the Related Art

Nowadays, the image display devices such as a personal computer (PC) and a portable information unit that displays the document have widely spread. Such an image display device analyzes the electronic data representing the document called the structured document, and generates and displays an image showing the document based on the analysis result. The structured document may be an XHTML, for example.

In an example of the XHTML, the logical structure information and the style information are described in a formatted manner for the document structure. A display device layouts electronic data (a visualization process for displaying the document information) based on the logical structure information and the style information. And the document represented by electronic data may be displayed with the layout changed.

The techniques for displaying the document so that it can be easily seen or understood by the operator have previously been proposed, employing the characteristics of such structured document. One of those conventional techniques is JP-A-11-3386 (patent document 1), for example.

The invention as described in patent document 1 is a display method for the information used in displaying the graphic chart such as graph or table. In this invention, when the image is changed by scrolling the graphic chart, or turning the page, the information regarding the graphic chart is displayed near the graphic chart.

By the way, the structured document may include not only the text but also the graphic chart such as figure, table or graph. In most cases, the document including the graphic chart contains a description of graphic chart in the text. When viewing such document, most of the users need to read the text in the description, while seeing the graphic chart.

However, the invention as described in the patent document 1 does not meet such requirements, and only displays the supplementary information in association with the graphic chart, which can not essentially be viewed by the user. Therefore, in the invention as described in the patent document 1, when the document consisting of the text and the graphic chart is displayed, the text including the description for the graphic chart can not be often displayed along with the graphic chart.

This invention has been achieved in the light of the above-mentioned problems, and it is an object of the invention to provide an image display device, an image display system and a program for executing an image displaying method by a computer, in which the text containing the description for graphic chart is displayed, along with the graphic chart, in displaying the document containing the graphic chart and text, whereby the document and the graphic chart can be simply contrasted.

### SUMMARY

In order to accomplish the above object, the present invention provides an image display device for displaying a document containing a text and a graphic chart relevant to the text on a display screen, comprising a document relevance determination section for determining the relevance between the text and the graphic chart contained in the document by analyzing the document, and a display timing control section for controlling the display start and end on the display screen for the graphic chart contained in the document, based on a display state on the display screen for the text determined to be relevant to the graphic chart by the document relevance determination section.

With this invention, the relevant text such as a description for the graphic chart can be displayed, while the graphic chart is being displayed. Also, when the display of the text is ended, the display of the graphic chart can be also ended. Therefore, it is possible to provide the display device in which the document and the graphic chart are always easily contrasted.

Also, the image display device may further comprise a layout decision section for deciding the arrangement of graphic chart and text to be displayed on the display screen, wherein the layout decision section restricts the spacing on the display screen between the graphic chart on the display screen and the text determined to be relevant to the graphic chart by the document relevance determination section to a prescribed length or less.

With this invention, the graphic chart and the text that are relevant to each other can be displayed adjacently on the display screen. Therefore, the relevance between the graphic chart and the text is easily understood.

Also, the display timing control section may make the display periods of the text and the graphic chart coincident by making almost coincident the display start and display end timings of the predetermined text and the graphic chart determined to be relevant to the text by the document relevance determination section, if the text or graphic chart displayed on the display screen is switched.

With this invention, the graphic chart and the text that are relevant start to be displayed at the same time, whereby it is possible to promptly take action, when it is necessary to refer to the graphic chart for the understanding of the text. Also, when the display of the text is end, the unnecessary graphic chart is erased immediately. This operation enhances the operability of the image display device.

Also, the display timing control section displays sequentially a plurality of texts relevant to one graphic chart, while the one graphic chart is being displayed, if there are the plurality of texts relevant to the one graphic chart, and displays sequentially a plurality of graphic charts relevant to one text, while the one text is being displayed, if there are the plurality of graphic charts relevant to the one text.

With this invention, if there are the plurality of texts relevant to the one graphic chart, the one graphic chart is displayed, while the plurality of texts are being displayed. This operation enhances the operability of the image display device.

Also, the image display device may further comprise a switching operation section for making an operation of switching the graphic chart or the text to be displayed on the display screen.

With this invention, the user can switch the image displayed on the display screen at will.

Also, the image display device may comprise a plurality of the display screens, the graphic chart and the text being displayed on different display screens, in which the display timing control section adjusts the display timing of the graphic chart and the text displayed on the different display screens.

With this invention, the display start or end for the images displayed on the plurality of display screens can be adjusted, based on the relevance. Therefore, the relevant text such as a description of the graphic chart can be displayed while the graphic chart is being displayed between the plurality of display screens. Also, when the display of the text is ended, the display of the graphic chart can be ended. Therefore, it is possible to provide the display device in which the document and the graphic chart are easily contrasted.

Also, the image display device may further comprise a display destination decision section, having the characteristic data concerning the characteristics of the plurality of display screens, for deciding the display screen that is a display destination of the graphic chart and the text based on the characteristic data.

With this invention, it is possible to automatically select the display screen having the characteristic adequate for the form of the document to be processed and display and document.

Also, the invention provides an image display system for displaying a document containing a text and a graphic chart, comprising a plurality of display screens and a display control device for controlling the display timing of an image displayed on each of the plurality of display screens, wherein the display control device comprises a document relevance determination section for determining the relevance between the graphic chart and the text contained in the document by analyzing the document, and a display timing control section for making coincident the display timings of the graphic chart displayed on any of the display screens and the text determined to be relevant to the graphic chart by the document relevance determination section on the other display screen.

With this invention, the relevant text such as a description of the graphic chart can be displayed while the graphic chart is being displayed. Also, when the display of the text is ended, the display of the graphic chart is ended. Therefore, it is possible to provide the display system in which the document and the graphic chart are easily contrasted.

Also, the invention provides an image display device for displaying an image representing a document on a first display screen, the image display device having at least the first display screen, comprising a display device connection section for connecting another display device having at least a second display screen to a self device, a connection determination section for determining whether or not another display device is connected by the display device connection section, a display destination decision section for selecting one of the first display screen and the second display screen as the display screen for displaying the graphic chart contained in the document, and selecting the other display screen as the display screen for displaying the text contained in the document, if it is determined that another display device is connected by the connection determination section, and an image display section for displaying the text and the graphic chart contained in the document on each of the first display screen and the second display screen selected by the display destination decision section.

With this invention, the image display device having at least the first display screen can be connected to the other display device having at least the second display screen. And if it is determined that the other display device is connected, it is possible to select one of the first display screen and the second display screen as the display screen for displaying the graphic chart contained in the document, and select the other display screen as the display screen for displaying the text contained in the document. Further, each of the text and the graphic chart contained in the document can be displayed on the selected first display screen or second display screen.

Therefore, according to the invention, the text or the graphic chart can be displayed on the first display screen or the second display screen, whereby the user can peruse both in contrast. Accordingly, the invention can provide the image display device in which when the document containing the graphic chart and the text is displayed, the text including a description of the graphic chart is displayed together with the graphic chart, whereby the document and the graphic chart can be simply contrasted.

Also, the image display device may further comprise a document relevance determination section for determining the relevance between the text and the graphic chart contained in the document by analyzing the document, and a display timing control section for displaying, based on a display state of the predetermined graphic chart or text on the first display screen, the graphic chart or text determined to be relevant to the predetermined graphic chart or text by the document relevance determination section on the second display screen.

With this invention, it is possible to determine the relevance between the text and the graphic chart contained in the document. And based on the display state of the predetermined graphic chart or text on the first display screen, the graphic chart or text relevant to the predetermined graphic chart or text can be displayed on the second display screen.

Also, with the invention, the text and the graphic chart relevant to each other can be displayed on the first display screen and the second display screen, and the display timings of both can be made coincident. Therefore, the user can peruse the graphic chart and the text relevant to each other by contrasting the document and the graphic chart efficiently. Also, if it is determined that another display device is not connected by the connection determination section, the display destination decision section may decide the display screen for displaying the graphic chart and the text contained in the document as the first display screen, the image display section may display the graphic chart and the text on the first display screen, and the display timing control section may display the graphic chart determined to be relevant to the text by the document relevance determination section on the first display screen, while the predetermined text is being displayed on the first display screen.

With this invention, if another display device is not connected, the graphic chart and the text relevant to each other can be displayed on the first display screen at the coincident display timing. Therefore, the user can peruse the graphic chart and the text relevant to each other in contrast, even if another display device is not connected.

Also, the invention provides an image display system for displaying a document containing a text and a graphic chart, comprising a plurality of display screens and a display control device for controlling the display timing of an image displayed on each of the plurality of display screens, wherein the display control device comprises a document relevance determination section for determining the relevance between the graphic chart and the text contained in the document by analyzing the document, and a display timing control section for controlling the display start and end on the display screen for the graphic chart displayed on any of the display screens, based on a display state on other display screens for the text that is determined to be relevant to the graphic chart by the document relevance determination section.

With this invention, the text such as a description of the graphic chart relevant to the graphic chart can be displayed, while the graphic chart is being displayed. Also, when the display of the text is ended, the display of the graphic chart can be also ended. Therefore, it is possible to provide the display system in which the document and the graphic chart are easily contrasted at any time.

Also, the invention provides an image display system comprising a first display device having at least a first display screen and a second display device having at least a second display screen and connected to the first display device, wherein the first display device comprises a display destination decision section for selecting one of the first display screen and the second display screen as the display screen for displaying the graphic chart contained in the document to be displayed, and selecting the other display screen as the display screen for displaying the text contained in the document, a document relevance determination section for determining the relevance between the graphic chart or text displayed on the first display screen selected by the display destination decision section and the graphic chart or text displayed on the second display screen by analyzing the document, and a display timing control section for displaying the graphic chart or text determined to be relevant to the graphic chart or text by the document relevance determination section on the second display screen, based on a display state of the predetermined graphic chart or text on the first display screen.

In this way, the invention provides the image display system composed of the first display device having the first display screen and the second display device having the second display screen. Also, the first display device can select one of the first display screen and the second display screen as the display screen for displaying the graphic chart contained in the document to be displayed, and select the other display screen as the display screen for displaying the text contained in the document. Further, the relevance between the graphic chart or text decided to be displayed on the first display screen and the graphic chart or text decided to be displayed on the second display screen is determined, and the graphic chart or text relevant to the graphic chart or text is displayed on the second display screen, based on a display state of the predetermined graphic chart or text on the first display screen.

With this invention, the texts or graphic charts relevant to each other can be displayed on the first display screen and the second display screen, and the display timings for both can be made coincident. Therefore, the user can peruse the graphic chart and the text relevant to each other in contrast, whereby it is possible to provide the image display system in which the document and the graphic chart are contrasted more efficiently.

Also, the invention provides a program for executing an image displaying method by a computer for use in an image display device having at least a first display screen for displaying the image representing a document on the first display screen, the program comprising a connection determination step of determining whether or not another display device having at least a second display screen is connected, a display destination decision step of selecting one of the first display screen and the second display screen as the display screen for displaying the graphic chart contained in the document, and selecting the other display screen as the display screen for displaying the text contained in the document, if it is determined that another display device is connected at the connection determination step, a document relevance determination step of determining the relevance between the graphic chart or text displayed on the first display screen and the graphic chart or text displayed on the second display screen by analyzing the document, and a display timing control step of displaying the graphic chart or text determined to be relevant to the graphic chart or text by the document relevance determination section on the second display screen, based on a display state of the predetermined graphic chart or text on the first display screen.

With this invention, it is determined whether or not another display device having the second display screen is connected, and one of the first display screen and the second display screen is selected as the display screen for displaying the graphic chart contained in the document, and the other display screen is selected as the display screen for displaying the text contained in the document, if it is determined that another display device is connected. Also, the relevance between the graphic chart or text displayed on the first display screen and the graphic chart or text displayed on the second display screen is determined, and the graphic chart or text relevant to the graphic chart or text is displayed on the second display screen, based on a display state of the predetermined graphic chart or text on the first display screen.

Hence, the texts or graphic charts relevant to each other are displayed on the first display screen and the second display screen, and the display timings for both can be made coincident. Therefore, the user can peruse the graphic chart and the text relevant to each other in contrast, whereby it is possible to provide the program for executing the image displaying method by the computer in which the document and the graphic chart are contrasted more efficiently.

### BRIEF DESCRIPTION OF THE DRAWINGS

FIGS. 1A and 1B are appearance views of an image display device according to an embodiment 1 of the present invention.

FIG. 2 is a block diagram of the image display device according to the embodiment 1.

FIG. 3 illustrates the logical structure of a basic document for document data processed by an arithmetic operation part as shown in FIG. 2.

FIG. 4 is a diagram illustrating more specifically the document data as shown in FIG. 3.

FIGS. 5A and 5B are views for explaining a processed result table in the arithmetic operation part as shown in FIG. 2.

FIGS. 6A, 6B and 6C are views for explaining the image represented by display data as shown in FIG. 2.

FIG. 7 is a flowchart for explaining a process performed by the image display device according to the embodiment 1.

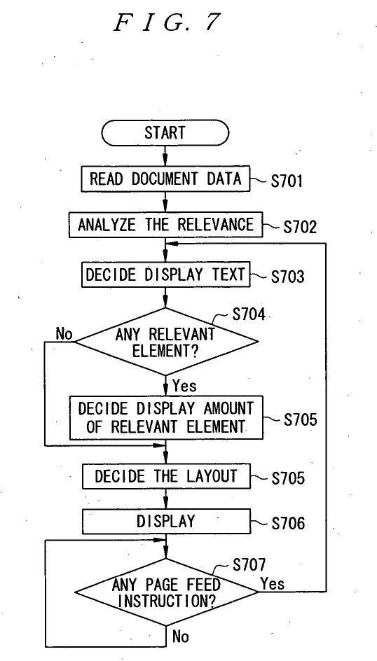

FIG. 8 is an appearance view of an image display device according to an embodiment 2 of the invention.

FIG. 9 is a diagram for explaining the configuration of a main image display unit in the image display device according to the embodiment 2 of the invention.

FIGS. 10A and 10B are views for explaining the arrangement pattern data as shown in FIG. 9.

FIGS. 11A, 11B and 11C are views showing the pages displayed on each of three display screens based on the arrangement patterns as shown in FIGS. 10A and 10B.

FIG. 12 is a view showing the appearance of an image display device according to an embodiment 3 of the invention.

FIG. 13 is a block diagram of the image display device according to the embodiment 3 of the invention.

FIGS. 14A and 14B are views for explaining the display part characteristic data as shown in FIG. 13.

FIGS. 15A and 15B are views for explaining the display part selection priority data as shown in FIG. 13.

FIGS. 16A and 16B are views showing the appearance of an image display system consisting of an image display device according to an embodiment 4 of the invention.

FIG. 17 is a block diagram for explaining the configuration of the image display device 1 and the image display device 2 as shown in FIGS. 16A and 16B.

FIG. 18 is a flowchart for explaining a program for executing an image displaying method by a computer, in which the image displaying method is performed in the image display system according to the embodiment 4 of the invention.

### DETAILED DESCRIPTION OF THE PREFERRED EMBODIMENTS

The preferred embodiments of an image display device and display system, and a program for executing a display control method by a computer according to the present invention will be described below with reference to the drawings. In the following embodiments, the embodiments 1 to 3 are the image display device and display system, and an embodiment 4 is the image display device and display system and a program for executing the display control method by a computer.

### Embodiment 1

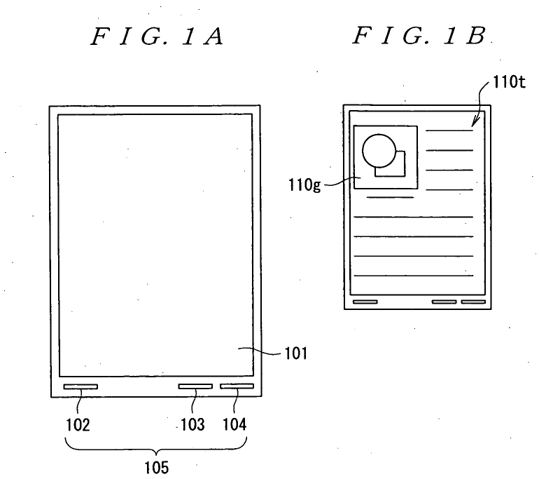

FIGS. 1A and 1B are appearance views of an image display device according to an embodiment 1, in which FIG. 1A illustrates the appearance of the image display device and FIG. 1B illustrates the layout of a document displayed on the image display device as shown in FIG. 1A. The image display device of the embodiment 1 is constructed as a display dedicated device having a thin-type display screen 101.

The image display device of the embodiment 1 comprises the display screen 101 and an operation portion 105 for performing an operation for switching the images displayed on the display screen 101, as shown in FIG. 1A. Also, the image display device displays a document containing a text and a figure, a graph or a table regarding the text (figure, graph and table are generically referred hereinafter to as a graphic chart), as shown in FIG. 1B.

An image represents the graphic chart or the text. In the embodiment 1, the document is configured in a range of image displayed on the display screen 101 at one time as a unit. This unit is denoted as one page. The operation portion 105 comprises a page backward button 103 and a page forward button 104 for switching the image displayed on the display screen 101 for every page, and a display fixing button 102 for fixing the displayed page to be continually displayed.

If the user presses the page forward button 104, the page displayed on the display screen 101 is moved forward by one page. Also, if the user presses the page backward button 103, the page displayed on the display screen 101 is moved backward by one page. Further, if the user presses the display fixing button 102, the page displayed when pressing the display fixing button 102 is continually displayed, regardless of the operation of the page forward button 104 or the page backward button 103. The fixed display is released by pressing the display fixing button 102 again.

Also, the image display device of the embodiment 1 displays both an image 110g of graphic chart contained in the document and an image 110t of text including a description of the image 110g, as shown in FIG. 1B. Under such display control, the user can read the image 110g while seeing the image 110t of text in the embodiment 1. Since the image display device has the display screen 101 alone in the embodiment 1, the image 110t and the image 110g are laid out on the display screen 101.

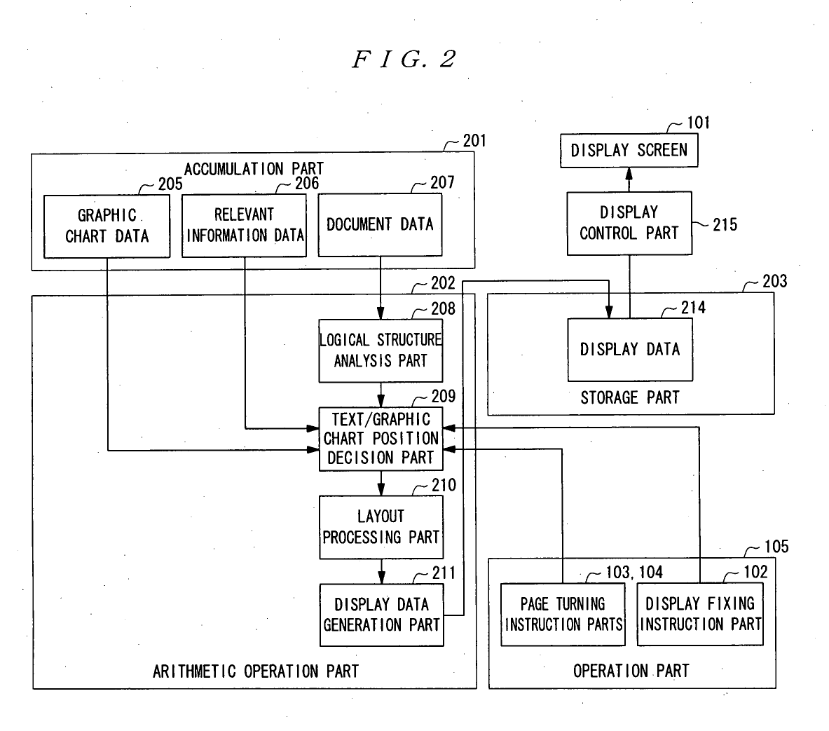

FIG. 2 is a block diagram of the image display device according to the embodiment 1. The image display device of the embodiment 1 deals with the document data of a structured document. And the image display device comprises an arithmetic operation part 202 for analyzing this document and determining the relevance between the graphic chart and the text contained in the document, and a display control part 215 for controlling the start and end of displaying the graphic chart contained in the document on the display screen 101 based on a display state of the text determined to be relevant to the graphic chart on the display screen 101.

The display state of the text means the state where the text is displayed or not displayed. In the state where the text is displayed, all of the text is displayed, or only a part of the text is displayed. Further, when a part of the text is displayed, the start and end of displaying the graphic chart may be controlled according to a proportion of the displayed text to the text of one screen.

Moreover, the arithmetic operation part 202 decides the arrangement (layout) of predetermined graphic chart contained in the document and the text determined to be relevant to the graphic chart on the display screen 101. Also, in deciding the layout, the spacing between the display position of the graphic chart and the display position of the text on the display screen 101 is restricted to a prescribed length or less. In this way, the image display device of the embodiment 1 displays the graphic chart and the description of graphic chart adjacently, clarifying the relevance between both. Such arithmetic operation part 202 functions as a document relevance determination section, a display timing control section and a display position control section.

Also, the image display device of the embodiment 1 comprises an accumulation part 201 for accumulating data of image (image data) arithmetically operated by the arithmetic operation part 202, and a storage part 203 for once storing data (display data) 214 generated by the arithmetic operation part 202 and expanding it into the image, as well as storing a program or the data used for the processing in the arithmetic operation part 202. The arithmetic operation part 202 reads the image data stored in the storage part 203 and displays it on the display screen 101, and controls the display timing and the layout of graphic chart and text on the display screen 101.

The accumulation part 201 accumulates the document data 207, the graphic chart data 205 and relevant information data 206. The document data 207 of the embodiment 1 is the structured document data in which the relevance between graphic chart and text is described. Also, the graphic chart data 205 is the real data of graphic chart specified in the document data 207, and the relevant information data 206 is the data of graphic chart or text, or mixture of graphic chart and text, specified by hyperlink.

The graphic chart data 205, the relevant information data 206 and the document data 207 are inputted into the arithmetic operation part 202. The arithmetic operation part 202 comprises a logical structure analysis part 208 for analyzing a logical structure of the document data 207 and determining the relevance between text and graphic chart, a text/graphic chart position decision part 209, a layout processing part 210 and a display data generation part 211. The text/graphic chart position decision part 209 specifies the graphic chart and the text to be displayed within a certain range of spacing, based on the analysis result of the logical structure analysis part 208 and decides the spacing between both the display positions.

The layout processing part 210 decides the layout of page containing the text and the graphic chart in accordance with the decided spacing. The display data generation part 211 generates the display data 214 according to the decided layout and transfers it to the storage part 203. The layout processing part 210 has a main function especially as a layout decision section in the arithmetic operation part 202.

The display control part 215 reads the display data 214 at any time, and sends it to the display screen 101 to display it. If the display screen 101 has a memory, the display control part 215 reads the display data 214, only when the display page is changed by a page turning instruction part composed of the page backward button 103 and the page forward button 104. Also, the display screen is memory less, the display data 214 is repeatedly read at regular time intervals.

The operation of the arithmetic operation part 202 will be described below more specifically.

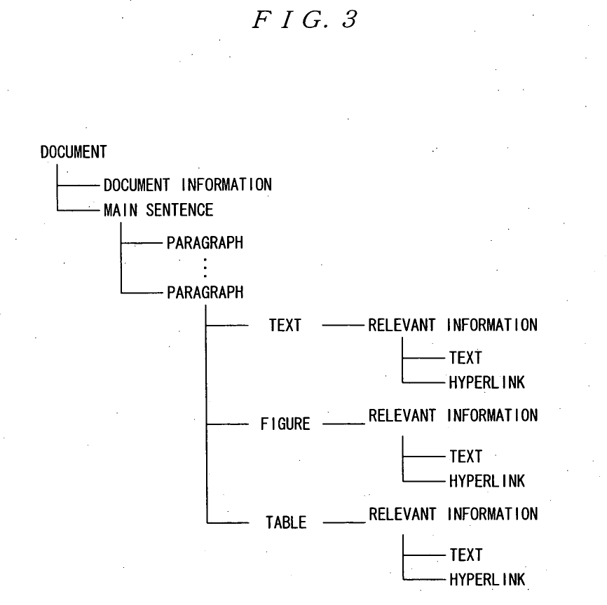

FIG. 3 illustrates the logical structure of a basic document for the document data 207 processed by the arithmetic operation part 202. The document is composed of the document information such as creation time and date, creator and title, and a main text of document. Also, the main text of document consists of plural paragraphs. Further, each paragraph contains the text, figure or table. Each of the text, figure and table has relevant information. The relevant information is added to the text such as description, or as a hyperlink. The hyperlink means a URL for jumping to another document or image.

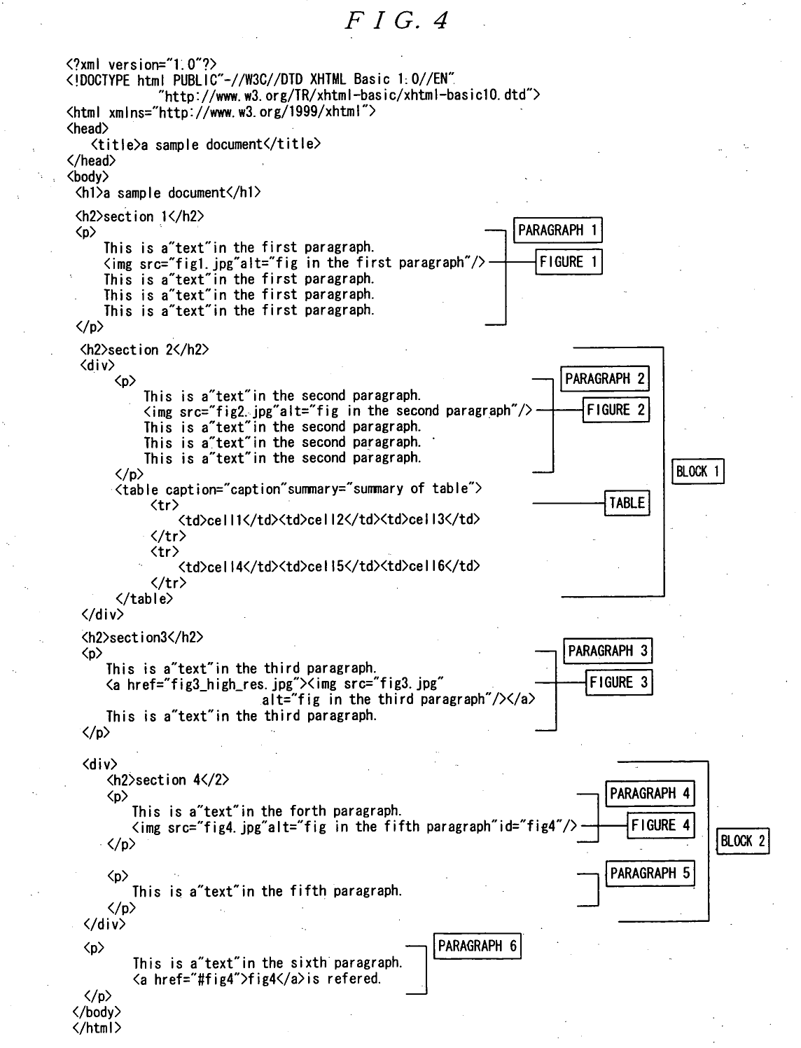

FIG. 4 illustrates the document data 207 more specifically. The illustrated document data is created in accordance with the standard of XHTML Basic 1.0 as recommended by W3C. Also, the illustrated document data 207 contains six paragraphs from paragraph 1 to paragraph 6, four figures of FIG. 1 to FIG. 4 and one table.

In FIG. 4, the document data from <p> to </p> corresponds to one paragraph. Also, the document data from <div> to </div> corresponds to one block. The block means a unit of document data capable of containing plural paragraphs, or the table in addition to the paragraph.

The paragraph 1 contains the notation of “fig1.jpg”. Therefore, the logical structure analysis part 208 determines that the text of paragraph 1 and FIG. 1 are relevant. Also, since the block 1 includes the paragraph 2, and the paragraph 2 contains the notation of “fig2.jpg”, it is determined that the paragraph 2 and FIG. 2 are relevant. Further, there is the notation of “table caption” indicating that caption is appended to the table in the block 1. Therefore, the logical structure analysis part 208 determines that all the text contained in the block 1 is relevant to the table.

Also, it is determined that the paragraph 3 contains FIG. 3, and has the hyperlink. It is determined that the block 2 contains the paragraphs 4 and 5, and the text of the paragraph 4 is relevant to the FIG. 4. Further, the paragraph 6 contains the notation of “#fig4” indicating the FIG. 4. The logical structure analysis part 208 determines that the paragraph 6 is relevant to the FIG. 4, beyond the paragraph.

The logical structure analysis part 208 analyzes the structured document, and records this result in the table (processed result table), as described above. The text/figure position decision part 209 decides the display position of the graphic chart or the text relevant to the graphic chart by referring to the result recorded in the table.

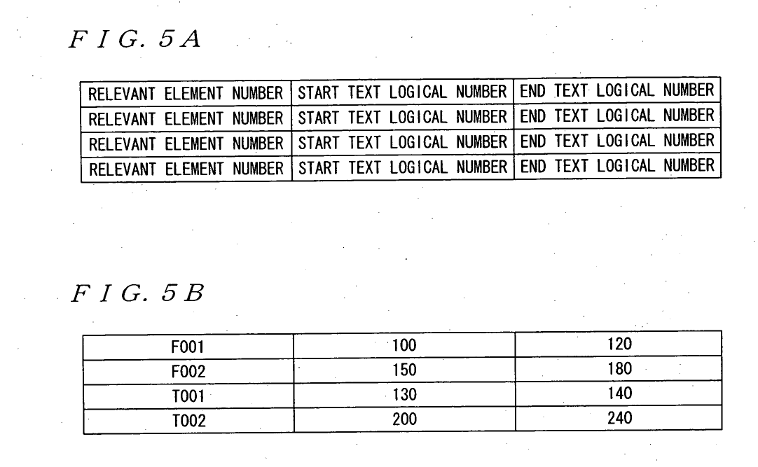

FIGS. 5A and 5B are views for explaining the processed result table. FIG. 5A shows the data recorded in the processed result table. In the processed result table, the relevant element such as figure or table is recorded with the number (relevant element number) such as FIG. 1 or table 1, as shown in FIG. 5A. Further, the start logical row number and the end logical row number of the text relevant to this relevant element number are recorded in association with the relevant element number.

The logical row is not the row number indicated as the layout result, but the logical row number as the data structure. Also, the processed result table as shown in FIG. 5A lists the relevant text with the figure or table as the key. Such a recording method of the table is contrived because the number of text logical rows is generally greater than the number of graphic charts.

FIG. 5B shows a specific example of the processed result table as shown in FIG. 5A. In FIG. 5B, F001 indicates the FIG. 001. In the example of FIG. 5B, the processed result table records that the FIG. 001 is relevant to the text from text logical row number 100 to number 120. Also, T001 indicate the table 01. In the example of FIG. 5B, the processed result table records that the table 001 is relevant to the text from text logical row number 130 to number 140.

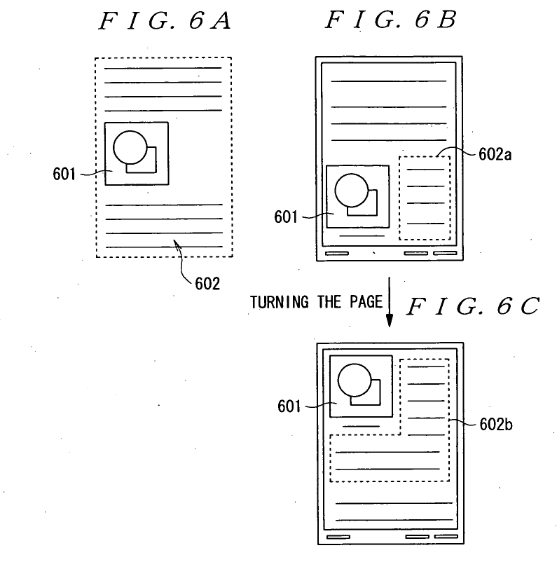

FIGS. 6A, 6B and 6C are views for explaining the image displayed by the display data 214. The display data 214 is the data generated through the layout process, based on the processed result table of FIGS. 5A and 5B.

In the embodiment 1, if the figure or table recorded in association in the processed result table is displayed, the text determined to be relevant to the figure or table is displayed in a certain range of spacing. Also, the periods for displaying the graphic chart and the text relevant to the graphic chart are made coincident.

That is, when the FIG. 601 and the text 602 are displayed in one page as shown in FIG. 6A, the layout processing part 210 arranges the text 602a relevant to the FIG. 601 in the text 602 displayed as one page so as to flow it around the FIG. 601, as shown in FIG. 6B. This arrangement condition may be implemented by setting the spacing between the display position of the FIG. 601 and the display position of the text 602a to be a predetermined distance or less.

The display position of the FIG. 601 may be decided on the basis of a point on the FIG. 601 or a point on the periphery of the FIG. 601. Also, the display position of the text 602a may be decided on the basis of a predetermined position within a range where the text 602a is displayed, or a point on the closed curve surrounding the display range.

Also, the spacing between the display position of the FIG. 601 and the display position of the text 602a may be the distance on the straight line connecting the points indicating the positions decided in the above way. Moreover, when such plural straight lines are considered, the shortest or longest distance of the conceivable straight lines may be adopted.

Moreover, in the embodiment 1, when the layout of the next page of the page as shown in FIG. 6B is decided, the display period of another graphic chart is made coincident with the display period of the text relevant to another graphic chart, if the FIG. 601 is changed to another graphic chart in the next page. That is, the text relevant to another graphic chart is displayed at the same time with another graphic chart, whereby the user can read the relevant text while seeing another graphic chart.

A process for making coincident the time interval (display period) of displaying the predetermined graphic chart and the time interval of displaying the text relevant to this graphic chart is enabled by making the display start and end timings of the graphic chart and the text roughly coincident.

In the embodiment 1, the layout processing part 210 lays out the FIG. 601 and the text 602a relevant to the FIG. 601 in the same page to generate the display data of one page, and does not lay out the FIG. 601 and the text 602a in the next page, so that the display start and display end timings for the FIG. 601 and the text 602a are coincident.

Also, if there are plural texts relevant to the graphic chart 601, plural texts relevant to the graphic chart 601 are sequentially displayed, while the graphic chart 601 is being displayed in the embodiment 1. In the example as shown in FIG. 6C, the FIG. 601 is relevant to the text 602a and the text 602b.

In this case, the layout processing part 210 arranges the text 602a to be displayed adjacent to the FIG. 601 in the page as shown in FIG. 6B. Next, if the page is changed, and the text 602b is arranged in the page instead of the text 602a, the FIG. 601 is also arranged in this page. Further, if the page is changed, and the page without having the text 602b and the text relevant to the FIG. 601 is laid out, the figure 601 is not arranged in this page. Through this process, when there are plural texts relevant to the figure, the display start and display end timings for the figure and the text can be made coincident in the embodiment 1.

The above process performed in the image display device of the embodiment 1 will be described below, employing a flowchart. The image display device of the embodiment 1 reads the document data recorded in a memory card (S701), and once accumulates it in the accumulation part 201. And the document structure of document data is analyzed in the logical structure analysis part 208 of the arithmetic operation part 202 and the relevance between the graphic chart and the text is recorded in the processed result table (S702).

Also, the text/graphic chart position decision part 209 firstly decides the text to be displayed (S703), and judges the presence or absence of relevant element such as figure, table or relevant information that is relevant to the text (S704). If there is no relevant element (S704: NO), the layout processing part 210 decides the layout of page by combining the texts of one page (S705). The display data generation part 211 generates the display data in accordance with the layout decided by the layout processing part 210 and transfers it to the display control part 215. As a result, the image representing the laid out page is displayed on the display screen 101 (S706).

Moreover, the text/graphic chart position decision part 209 judges whether or not there is any instruction of turning the pages from the page turning instruction parts 103 and 104 (S707). If there is any instruction of turning the pages (S707: Yes), a process for deciding the layout of the next page is performed. On the other hand, if there is no instruction of turning the pages (S707: No), the image display device waits till the instruction is made.

At step S704, if it is judged that there is relevant element regarding the text (S704: Yes), the display screen for displaying the relevant element is decided. In the embodiment 1, since the display screen 101 is only provided for the display device, it is judged that the relevant element is displayed along with the text on the display screen 101 at step S706.

Also, if there is relevant element, the layout processing part 210 lays out the page to display the graphic chart and the text in one page (S705).

The image display device of the embodiment as described above can display the text relevant to the graphic chart such as description of the graphic chart, while the graphic chart is being displayed. Also, if the display of the text is ended, the display of the graphic chart can be also ended. Therefore, the image display device in which the document and the graphic chart are easily contrasted at any time is provided. Particularly, if there are plural texts relevant to one graphic chart, the graphic chart is displayed continually, while the plural texts are displayed, whereby the text and the graphic chart can be contrasted more easily.

Also, the image display device of the embodiment 1 can display the graphic chart and the text relevant to each other adjacently on the display screen. Therefore, the relevance between the graphic chart and the text is easily understood.

In the embodiment 1 as described above, the relevance between the text and the graphic chart is specified from the logical structure of structured document. However, the embodiment is not limited to the above configuration, but the relevance between the graphic chart and the text may be judged by other methods. Another method for judging the relevance between the graphic chart and the text involves estimating the relevance between the graphic chart and the text from the meanings of the text. With this method, if there is a sentence of “as shown in FIG. 3 in chapter 3”, even without being marked up, for example, it is esteemed that this text and the FIG. 3 are relevant.

Also, the image display device of the embodiment 1 is not limited to displaying the text and the graphic chart that are relevant at the almost same timings. That is, the image display device of the embodiment 1 can change a proportion of the displayed text to the text of one screen, when a part of the text is displayed. Also, the image display device of the embodiment 1 can display a part of the graphic chart and change the display range according to the proportion of the displayed text. In this case, the image display device of the embodiment 1 can scroll the graphic chart relevant to the text along with scrolling the text.

### Embodiment 2

An embodiment 2 of the invention will be described below. For the explanation of the embodiment 2, the sake or like parts are designated by the same reference numerals in the embodiments 1 and 2, and not fully described here.

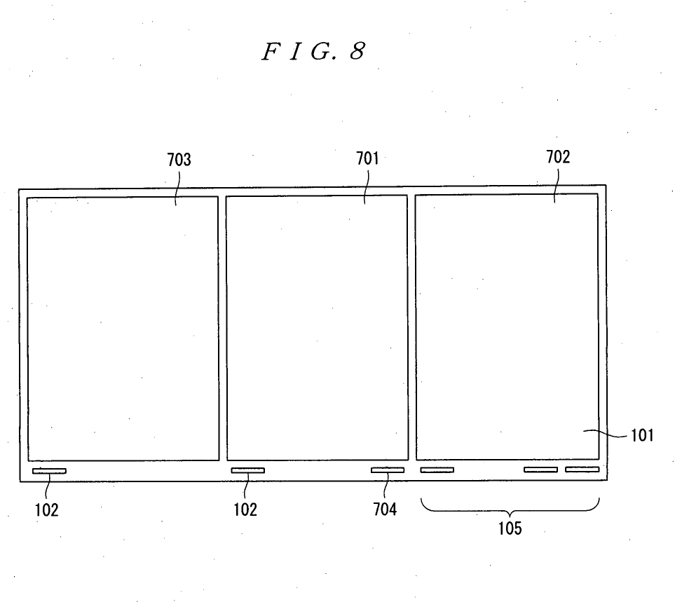

FIG. 8 is a view for explaining the appearance of an image display device according to the embodiment 2. The image display device of the embodiment 2 has an image display unit 701 connected to the image display units 702 and 703. Each of the image display units 701 to 703 has a display screen 101, and the image display device of the embodiment 2 has a total of three display screens.

In the image display device of the embodiment 2, the text and the graphic chart are displayed on different display screens. Therefore, the arithmetic operation part 202 adjusts the display timing of displaying the text and the graphic chart on different display screens.

In the embodiment 2, the image display unit 701 has the arithmetic operation part 202, like the image display device as described in the embodiment 1, and the image display units 702 and 703 are only involved in the process for displaying the image on the display screen 101 employing the display data in a simple configuration. The image display device of the embodiment 2 has the operation part 105, like the embodiment 1, and the display fixing button 102 is provided for each image display unit. Also, the image display unit 701 is provided with an arrangement switching button 704 for switching the images displayed on three display screens 101.

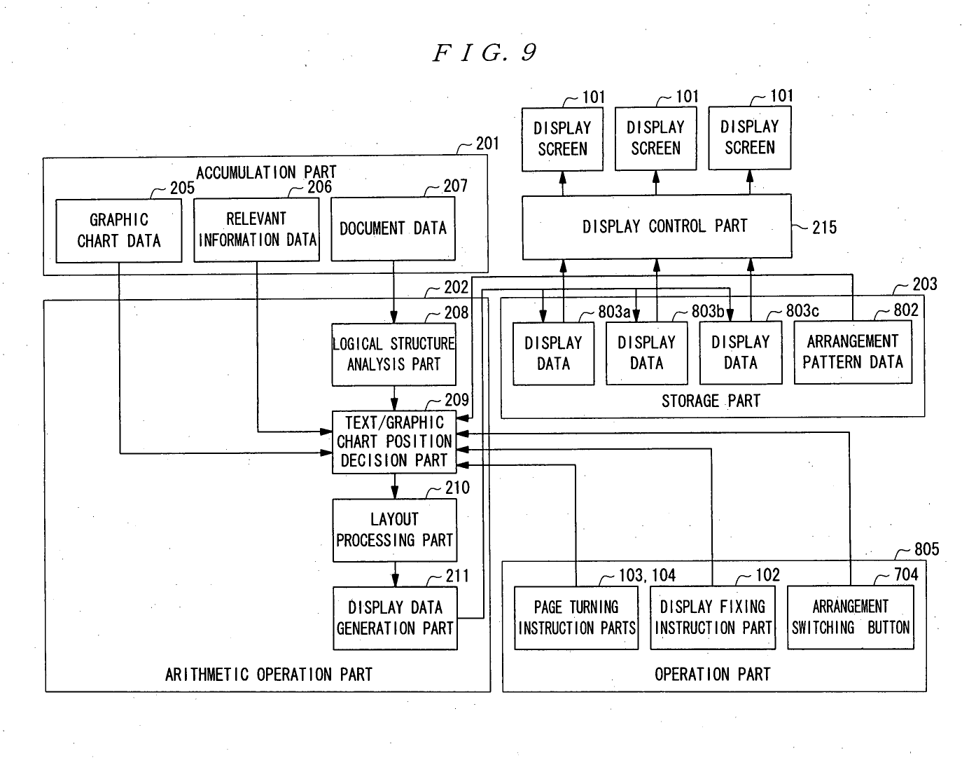

FIG. 9 is a diagram for explaining the configuration of the image display unit 701 in the image display device of the embodiment 2. In the arithmetic operation part 202 of the image display unit 701, the logical structure analysis part 208 analyzes a logical structure of document and records the relation between the graphic chart and the text in the processed result table, as in the embodiment 1. However, the text/graphic chart display destination decision part 801 does not lay out the graphic chart and the text in one page as in the embodiment 1, but decides on which display screen 101 each of the graphic chart and the text is displayed.

In deciding the display screen 101 for displaying the graphic chart and the text, the image display device of the embodiment 2 stores beforehand the arrangement pattern data 802 in the storage part 203. The text/graphic chart display destination decision part 801 decides the display screen 101 for displaying the graphic chart or the display screen for displaying the text by referring to the arrangement pattern data 802.

The layout processing part 210 lays out the page displayed on each display screen 101. The display data generation part 211 generates the display data 803a, 803b and 803c corresponding to three pages that are displayed on the display screens 101, and transfers them to the storage part 203. The display control part 215 transfers the display data 803a, 803b and 803c to the three display screens 101 and displays them.

The images displayed on the three display screens 101 can be changed in the pattern by the user operating the arrangement switching button 704.

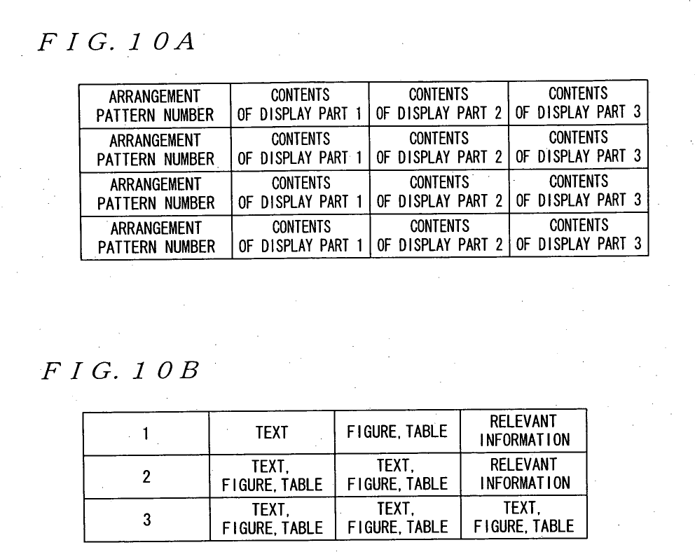

FIGS. 10A and 10B are views for explaining the arrangement pattern data 802. FIG. 10A illustrates the contents of data stored as the arrangement pattern data. The arrangement pattern data are data employed when the text/graphic chart display destination decision part 801 decides on which display screen 101 to arrange the text, figure, table and relevant information, as shown in FIG. 10A. The arrangement pattern-data 802 has a table structure with the number of specifying the arrangement pattern, for example, data of the page displayed on the display screen 101 of the image display unit 701, data of the page displayed on the display screen 101 of the image display unit 702 and data of the page displayed on the display screen 101 of the image display unit 703.

FIG. 10B illustrates a specific example of the table as shown in FIG. 10A. In the example as shown in FIG. 10B, the arrangement pattern 1 indicates that the text is displayed on the display screen 101 of the image display unit 701 and the graphic chart is displayed on the display screen 101 of the image display unit 702. Further, the relevant information is displayed on the display screen 101 of the image display unit 703.

Also, in the arrangement pattern 2, the text and graphic chart are displayed on the display screens 101 of the image display units 701 and 702, and the relevant information is displayed on the display screen 101 of the image display unit 703. Further, in the arrangement pattern 3, the text and the graphic chart are displayed on all the display screens 101 of the image display units 701 to 703.

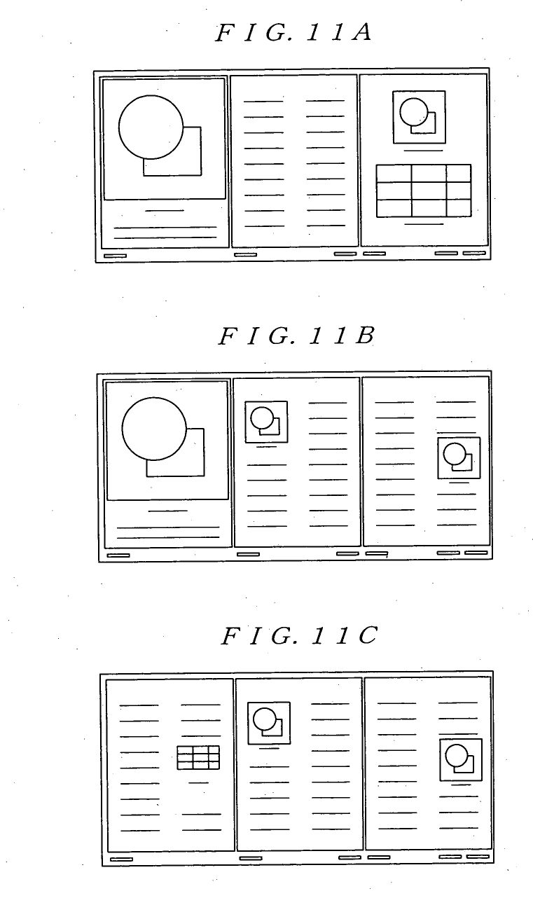

FIGS. 11A, 11B and 11C are views showing the pages displayed on each of the three display screens 101 based on the arrangement pattern as shown in FIGS. 10A and 10B. FIG. 1A shows the pages displayed on the display screens 101, based on the pattern 1 as shown in FIG. 10B. Also, FIG. 11B shows the pages displayed on the display screens 101, based on the pattern 2 as shown in FIG. 10B, and FIG. 11C shows the pages displayed on the display screens 101, based on the pattern 3 as shown in FIG. 10B.

In the embodiment 2, when the layout processing part 210 of the arithmetic operation part 202 lays out the pages represented by the display data 803a to 803c, the graphic chart and the text that are relevant, and relevant information start to be displayed on three display screens 101 at the same time, and end to be displayed, whereby the display periods for the graphic chart and the text that are relevant are made coincident. Also, if there are plural texts relevant to the graphic chart, the arrangement is made such that the relevant graphic chart is laid out in the page displayed in the same period as the text, while the text is being displayed.

In the embodiment 2, the text/graphic chart display destination decision part 801 may not only decide the display screen that is the destination of displaying the graphic chart and the text, but also arrange the text adjacently to the relevant graphic chart on each of the display screens 101 that is the display destination, as in the embodiment 1.

In the embodiment 2 as described above, the relevant text such as description of graphic chart may be displayed, while the graphic chart is being displayed, on the plural display screens. Also, when the display of the text is ended, the display of the graphic chart is also ended. Therefore, it is possible to provide the image display device in which the text and the graphic chart are easily contrasted at any time.

In the embodiment 2, the image display device equipped with plural display screens is adopted in the invention. However, the embodiment 2 is not limited to the above configuration, but a PC may be applied to the image display unit 701, and combined with an external auxiliary display unit to configure the display system.

### Embodiment 3

An embodiment 3 of the invention will be described below. For the explanation of the embodiment 3, the same or like parts are designated by the same reference numerals as in the embodiments 1 and 2, and not fully described.

An image display device of the embodiment 3 comprises plural display screens, with characteristic data concerning the characteristics of the plural display screens. And the display screen that is the display destination of the graphic chart and text is decided based on the characteristic data.

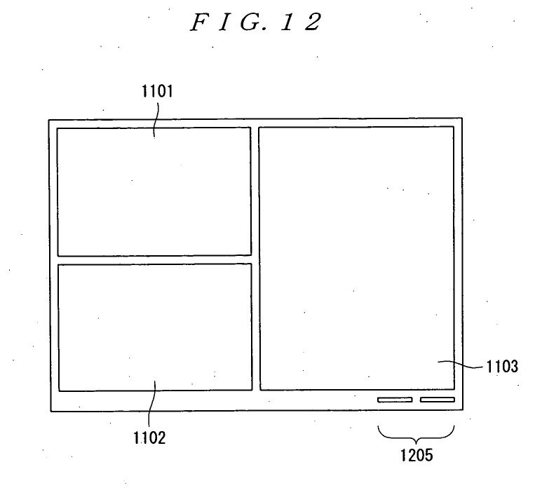

FIG. 12 is a view for explaining the appearance of the image display device according to the embodiment 3. The image display device of the embodiment 3 has three display screens 1110, 1102 and 1103. The display screens 1101 to 1103 have different characteristics. As the characteristic of each display screen, for example, a display screen 1101 can display the color image at meddle definition of image. This display screen 1101 is suitable for displaying the figure and table.

Also, a display screen 1102 can display the color image at low definition of image, but at high speed. This display screen 1102 is suitable for displaying the moving picture. Further, a display screen 1103 can display the white and black image at high definition. This display screen 1103 is suitable for displaying the characters.

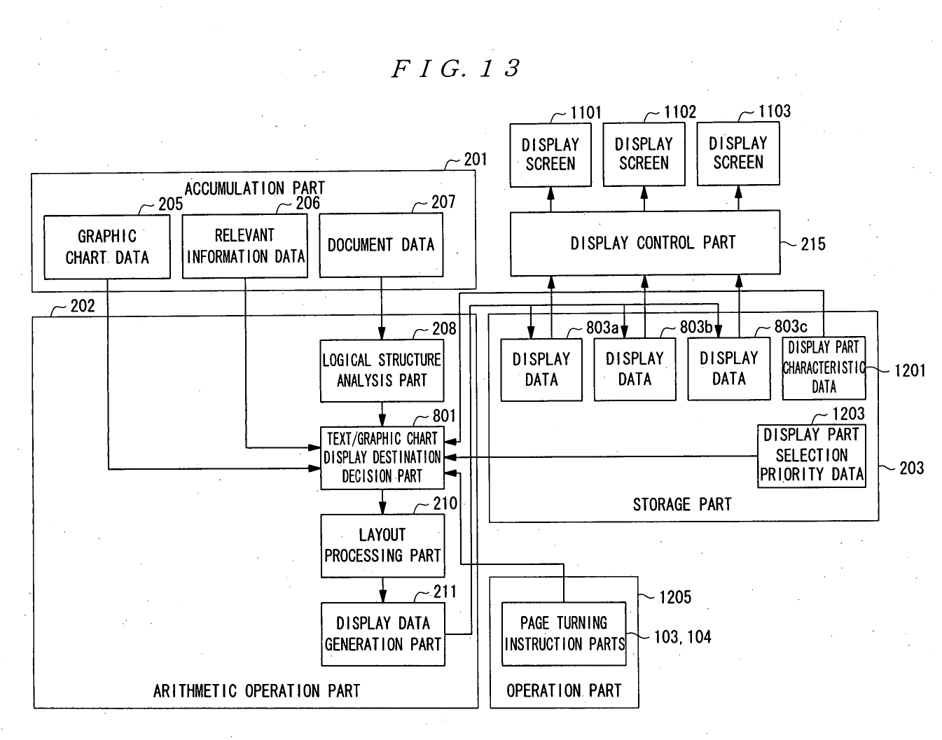

FIG. 13 is a block diagram of the image display device of the embodiment 3. The configuration of the image display device as shown in FIG. 13 is fundamentally the same as the configuration described in the embodiment 2 in connection with FIG. 9. However, in the image display device of the embodiment 3, the storage part 203 has the display part characteristic data 1201 indicating the characteristics of the display screens 1101 to 1103, and the display part selection priority data 1203 indicating the priority to be referred to in selecting the display screen.

Also, in the image display device of the embodiment 3, the text/graphic chart display destination decision part 801 decides the display destination of graphic chart or text by referring to the display part characteristic data 1201 or the display part selection priority data 1203. Therefore, an operation part 1205 only comprises the page turning instruction parts 103 and 104.

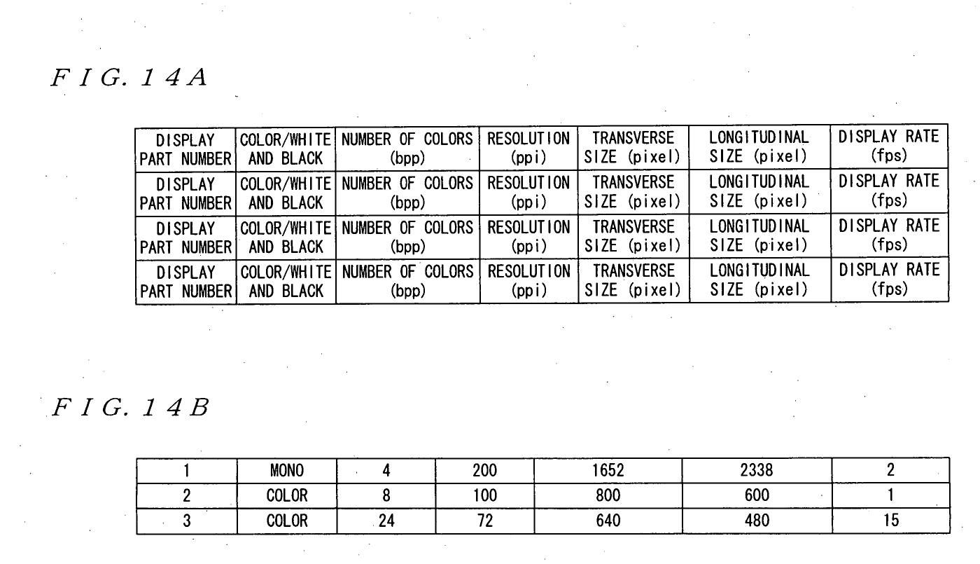

In the arithmetic operation part 202 of the embodiment 3, the logical structure analysis part 208 analyzes a logical structure of document and records the relation between the graphic chart and the text in the processed result table. The text/graphic chart display destination decision part 801 decides on which of the display screens 1011 to 1103 each of the graphic chart and the text is displayed. FIGS. 14A and 14B are views for explaining the display part characteristic data 1201, in which FIG. 14A shows the contents of data and FIG. 14B shows a specific example of data.

The display part characteristic data 1201 includes the display part number to specify the display screens 1101 to 1103, distinction of color or white and black of the display screen corresponding to the display part number, the number of displayable colors, the resolution and the size.

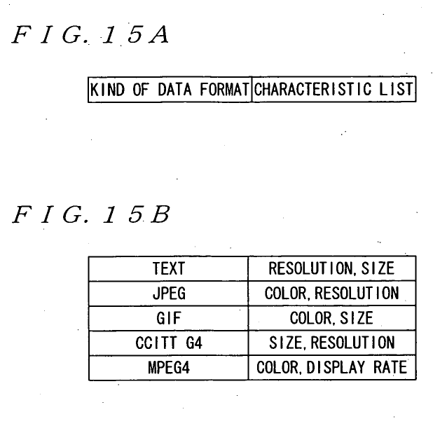

FIGS. 15A and 15B are views for explaining the display part selection priority data 1203, in which FIG. 1SA shows the contents of data and FIG. 15B shows a specific example of data. The display part selection priority data 1203 includes the kind of data form such as TEXT or JPEG, and the display condition (resolution, distinction of color or white and black) appropriate for the kind of data.

The display part characteristic data 1201 and the display part selection priority data 1203 are inputted into the text/graphic chart display destination decision part 801. The text/graphic chart display part decision part 801 retrieves the condition appropriate for the display by contrasting the kind of graphic chart or text data to be processed with the display part selection priority data 1203. And it decides the display screens 1101 to 1103 having the characteristic conforming to the condition of display obtained as a result of retrieval.

The selection of the display screens 1101 to 1103 is made, for example, to preferentially select the display screen having the highest “resolution” in the display part characteristic information for the data of text format. Moreover, if there are display screens having the equal resolution, the display screen having the highest “size” is preferentially selected. Also, in selecting the display part for displaying the data of JPEG format, the display screen having the highest “COLOR” characteristic is preferentially selected. If there are display screens having the equal color characteristic, the display screen having the highest “resolution” is preferentially selected.

The layout processing part 210 lays out the page displayed on each of the display screens 1101 to 1103. The display data generation part 211 generates the display data 803a, 803b and 803c corresponding to three pages that are displayed on the display screens 1101 to 1103, and transfers them to the storage part 203. The display control part 215 transfers the display data 803a, 803b and 803c to the three display screens 1101 to 1103 and displays them.

With the embodiment 3 as described above, the display screen having the characteristic adequate for the format of document data to be processed can be automatically selected to display the document.

### Embodiment 4

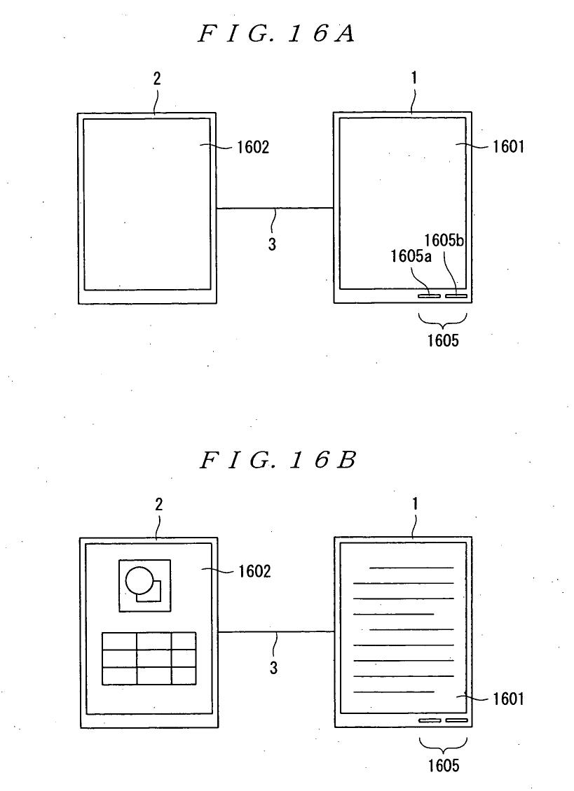

FIGS. 16A and 16B are views showing the appearance of an image display system made up of the image display devices according to an embodiment 4 of the invention. The image display system comprises an image display device 1 having a display 1601 for displaying the image representing the document on the display 1601, and an image display device 2 having a display 1602, which are connected by a cable 3 such as USB (Universal Serial Bus). The image display device 1 and the image display device 2 may be connected or disconnected at will.

Also, the image display system of the embodiment 4 displays the graphic chart and the text on different displays 1601 and 1602 in the image display system, when displaying the document including the graphic chart and the text, as shown in FIG. 16B. With this configuration, the image display system of the embodiment 4 displays the text containing the description for the graphic chart, along with the graphic chart in contrast to the graphic chart in the document.

In the embodiment 4, the graphic chart and the text are displayed on different displays 1601 and 1602, while the image display device 1 and the image display device 2 are connected. Also, if the image display device 1 and the image display device 2 are separated in a state where the graphic chart and the text are displayed on different displays 1601 and 1602, the graphic chart and the text are displayed on the display 1601.

In the display system of FIG. 16B, the text is displayed on the display 1601 of the display device 1, and the graphic chart is displayed on the display 1602 of the display device 2. Also, the image display device 1 comprises an operation portion 1605 for performing an operation for switching the screen-displayed on the display screen 1601 (the operation for switching the screen for the document of plural pages is referred to as turning the page). The operation part 1605 comprises a page forward button 1605a and a page backward button 1605b.

The page forward button 1605a is the button for moving forward the screen of the display 1601 by one page by being pressed at a time. The page backward button 1605b is the button for moving backward the screen of the display 1601 by one page by being pressed at a time.

With this configuration, the user can operate the operation part 1605 to turn the pages, while reading the text displayed on the display 1601 of the display device 1. The image display system of the embodiment 4 changes the graphic chart on the display 1602 when turning the page on the display 1601, the as will be described later. Therefore, the user can contrast the text displayed on the display 1601 with the corresponding graphic chart without operating the display 1602.

Though the image display device 1 has the single display 1601 and the image display device 2 has the single display 1602 in the example of FIGS. 16A and 16B, each of the image display devices 1 and 2 may have at least one or more displays.

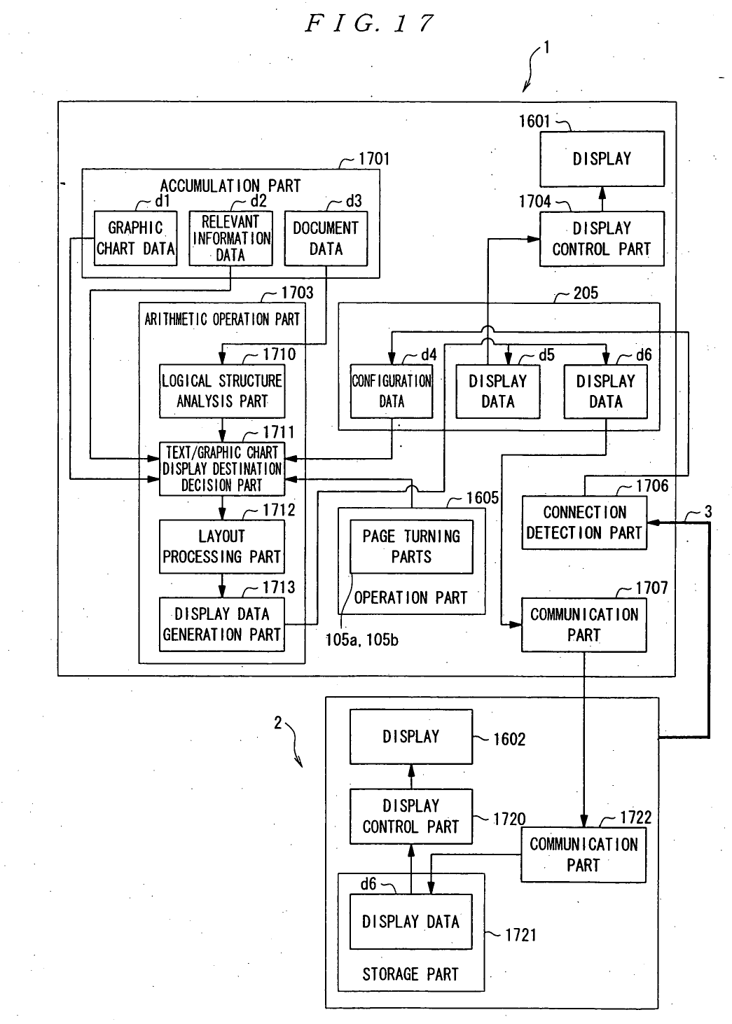

FIG. 17 is a block diagram for explaining the configuration of the image display device 1 and the image display device 2 as shown in FIGS. 16A and 16B. In the embodiment 4, each of the image display device 1 and the image display device 2 is constituted as a so-called electronic viewer that is employed to peruse the contents of a book or the business document. The image display device 1 and the image display device 2 employ the liquid crystal for the displays 1601 and 1602. In the embodiment 4, it is supposed that the display 1601 and the display 1602 have the same characteristics.

Also, the image display device 2 is connected to the image display device 1 by the cable 3. Therefore, the image display device 1 has an interface for connecting the self device (image display device 1) to the image display device 2. The interface may be the USB, for example, with a function of detecting that the image display device 2 is connected to the image display device 1. This interface serves as a connection detection part 1706 functioning as a display device connection section.

The detection result of the connection detection part 1706 is written as configuration data d4 into a storage part 1705.

An arithmetic operation part 1703 reads the written configuration data d4 and judges whether or not the image display device 2 is connected to the image display device 1, namely, the configuration of the image display system.

The image display device 1 comprises an accumulation part 1701 for reading and accumulating the data of book from a memory card, not shown, an arithmetic operation part 1703 for generating the display data for displaying the image of graphic chart (graphic chart image) or the image of text (text image) displayed on the displays 1601 and 1602 based on the data accumulated in the accumulation part 1701, the storage part 1705 for storing the configuration data to determine the presence or absence of the generated display data or connection of the image display device 2, a display control part 1704 for controlling the display 1601 to display the display data transferred to the display 1601 in the stored display data on the display 1601, and a communication part 1707 for transferring the display data displayed on the display 1602 in the stored display data to the display 1602 of the image display device 2.

The documents treated by the image display devices of the embodiment 4 include the graphic chat data d1, the relevant information data d2 and the document data d3. The graphic chart data d1 is the data for displaying the graphic chart contained in the document. The relevant information data d2 is the data indicating information of the link destination etc. contained in the document. The document data d3 is the data indicating the text corresponding to the main sentence in structured form. The accumulation part 1701 accumulates the data of document to be displayed that is read from the memory-card as graphic chart data d1, relevant information data d2 and document data d3.

The graphic chart data d1, relevant information data d2 and document data d3 of the embodiment 4 have a logical structure as illustrated in FIG. 3. Also, the document data d3 is the same kind of data as the document data 207 as illustrated in FIG. 4.

The arithmetic operation part 1703 comprises a logical structure analysis part 210, a text/graphic chart display destination decision part 211, a layout processing part 212 and a display data generation part 213.

The logical structure analysis part 210 analyzes the document and determines the relevance between text and graphic chart contained in the document. The text/graphic chart display destination decision part 211 selects one of the display 1601 or the display 1602 as the display screen displaying the graphic chart contained in the document, and selects the other display not selected as the display displaying the graphic chart as the display displaying the text contained in the document. The text/graphic chart display destination decision part 211 of the embodiment 4 selects the display 1601 as the display for displaying the text and selects the display 1602 as the display for displaying the graphic chart.

The layout processing part 212 lays out the image of each page displayed on the displays 1601 and 1602 based on the relevance between the text and the graphic chart that are determined by the logical structure analysis part 210. In the embodiment 4, the page of the graphic chart on the display 1602 is switched as the page of the text displayed on the display 1601 is switched.

Therefore, the layout processing part 212 displays the graphic chart determined to be relevant to the text by the logical structure analysis part 210 on the display 1602, while a predetermined text is being displayed on the display 1601, by laying out the graphic chart relevant to the text, in the page of graphic chart displayed in conjunction with the page of the predetermined text displayed on the screen of the display 1601. This layout processing part 212 functions as a display timing control section in the embodiment 4.

The embodiment 4 is not limited to the form in which the text is displayed on the display 1601 and the graphic chart is displayed on the display 1602. The graphic chart may be displayed on the display 1601 and the text relevant to this graphic chart may be displayed on the display 1602.

The display data generation part 213 generates the display data for displaying the image of text and the image of graphic chart according to the layout decided by the layout processing part 212. And the display data generation part 213 transfers the display data d5 of the image of text displayed on the display 1601 and the display data d6 of the image of graphic chart displayed on the display 1602 to the storage part 1705. The display data d5 and the display data d6 transferred to the storage part 1705 are once stored in the storage part 1705.

The display data d5 stored in the storage part 1705 is transferred from the storage part 1705 to the display control part 1704. The display control part 1704 draws the text on the display 1601, based on the transferred display data, and forms the image of one page.

Also, the display data d6 is passed from the storage part 1705 to the communication part 1707, and further transferred via the communication part 222 to the image display device 2. The display data d6 is once store in the storage part 221 of the image display device 2, and then transferred to the display control part 220. The display control part 220 draws the graphic chart on the display 1602, based on the transferred display data, and forms the image of one page.

The layout processing part 212, the display data generation part 213 and the display control parts 1704, 220 function as an image display section for the display system of the embodiment 4.

The operation of the image display system will be described below. In the embodiment 4, the logical structure analysis part 1710 analyzes the data d3 that is structured document and then its result is recorded in the table (processed result table) as shown in FIGS. 5A and 5B. The contents recorded in the processed result table are sent to a text/graphic chart display destination decision part 1711. The text/graphic chart display destination decision part 1711 retrieves the presence or absence of figure or table relevant to the text in the contents recorded in the processed result table. As a result of retrieval, if there is any figure or table relevant to the text, this figure or table is judged to be displayed.

Also, the text/graphic chart display destination decision part 1711 reads the configuration data d4, and judges the configuration of the image display system. In the embodiment 4, since the image display device 2 is connected to the image display device 1, the text/graphic chart display destination decision part 1711 decides the display destination of text to the display 1601 and the display destination of graphic chart to the display 1602. Moreover, the contents of decision and the relevance between text and graphic chart are sent to the layout processing part 1712.

The layout processing part 1712 of the embodiment 4 decides the layout of the page for the text displayed on the display 1601, and decides the layout in displaying the graphic chart-relevant to the text on the display 1602. The layout information is sent to a display data generation part 1713.

The display data generation part 1713 generates the display data of one page displayed on each of the displays 1601 and 1602 according to the decided layout.

In the embodiment 4, fundamentally, the display data of one page is generated every time the screen of the display 1601 is switched by the page turning parts 1605a and 1605b. The connection detection part 1706 monitors the connection or disconnection of the image display device 2, and if there is a change in the connection state, the configuration data stored in the storage part 1705 is updated with the contents indicating the disconnection of the image display device 2.

The text/graphic chart display destination decision part 1711 decides the display screen for displaying the graphic chart or text contained in the document as the display 1601, if the disconnection of the image display device 2 is detected by updating the configuration data. This contents are sent to the layout processing part 1712, which lays out the image of graphic chart with the text displayed on one screen of the display 1601, when the page switching operation is made at the next time. The layout contents are sent to the display data generation part 1713, which generates the display data for displaying the text and the graphic chart on the display 1601 according to the layout.

The display data generation part 1713 transfers the display data to the storage part 1705 by appending the information indicating that the transfer destination is the display 1601 to the generated display data. The transferred display data is once stored in the storage part 1705, and then transferred to the display control part 1704. The display control part 1704 draws the image on the display 1601 based on the transferred display data.

The layout processing part 1712 receives the relevance between text and graphic chart from the text/graphic chart display destination decision part 1711, when the connection of the image display device 2 is released. The layout processing part 1712 lays out the text and the graphic chart relevant to this text in the same page, whereby the graphic chart relevant to this text is displayed on the display 1601, while the predetermined text is being displayed on the display 1601.

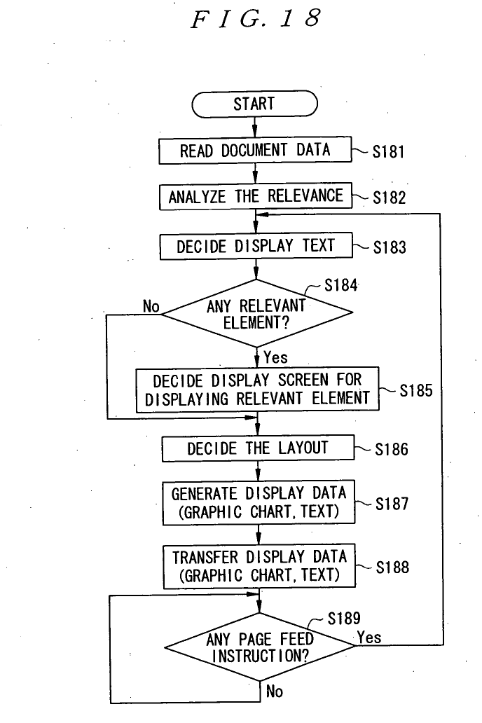

FIG. 18 is a flowchart for explaining a program for executing an image displaying method for use in the image display system of the above described embodiment 4 by a computer. The image display system firstly reads the data of document containing the document data (S181). The logical structure analysis part 1710 analyzes the relevance between text and graphic chart contained in the document from the document data in the read data (S182).

The text/graphic chart display destination decision part 1711 decides the text to be displayed, based on the analysis result at step S182 (S183) Further, it is judged whether or not any figure or table (relevant element) relevant to the text to be displayed (S184). If there is no relevant element (S184: No), the layout processing part 1712 decides the layout of the screen for displaying the text on the display 1601 (S186).

On the other hand, at step. S184, if it is judged that there is any relevant element in the text (S184), the text/graphic chart display destination decision part 1711 decides the display for use to display the relevant element such as figure or table (S185). In this case, the layout processing part 1712 decides the layout of the image displayed on each of the display 1601 and the display 1602 for displaying the relevant element (S186).

The display data generation part 1713 generates the display data d5 for displaying the text and the display data d6 for displaying the graphic chart. And the display data d5 with the information indicating the transfer destination such as display 1601 or display 1602 appended is transferred to the storage part 1705 (S188). The display data d5 and d6 transferred to the storage part 1705 are transferred to the display 1601 and the display 1602 as the transfer destination respectively, and displayed as the image.

Also, the text/graphic chart display destination decision part 1711 judges whether or not the page feed is instructed by the operation part 1605 (S189). If the page feed is instructed (S189: Yes), the text/graphic chart display destination decision part 1710 decides the text to be displayed at the next time (S183), whereby the display data for the text or graphic chart to be displayed at the next time is generated. Also, if there is no instruction of the page feed, the image display system waits till the page feed is instructed.

A program for executing the image displaying method of the above described embodiment 4 by a computer is stored in a computer readable recording medium such as CD-ROM, floppy (registered trademark) disk (FD) or DVD in a file of installable form or executable form, and provided. Also, the program for executing the image displaying method of the embodiment 4 by the computer may be stored in the computer connected to a network such as internet, and downloaded via the network. Alternatively, it may previously be stored in and provided from a non-volatile memory in the device.

As described above, the image display system of the embodiment 4 displays the text or graphic chart on the display 1601 and the display 1602, whereby the user can peruse both in contrast. Accordingly, the embodiment 4 may provide the image display system in which, when the document containing the graphic chart and the text is displayed, the text including the description of graphic chart is displayed, together with the graphic chart, whereby the document and the graphic chart are contrasted at any time.

Also, in the embodiment 4, the text and the graphic chart having relevance to each other are displayed on the display 1601 and the display 1602, and the display timings for both can be made coincident. Therefore, the user can peruse the graphic chart and the text relevant to each other, whereby the image display system in which the document and the graphic chart are contrasted more efficiently can be provided.

What is claimed is:

1. An image display device for displaying a document containing a text and a graphic chart relevant to said text on a display screen, comprising:
a document relevance determination section for determining the relevance between the text and the graphic chart contained in the document by analyzing said document; and
a display timing control section for controlling the display start and end on said display screen for the graphic chart contained in said document, based on a display state on said display screen for the text determined to be relevant to said graphic chart by said document relevance determination section.

2. The image display device according to claim 1, further comprising a layout decision section for deciding the arrangement of graphic chart and text to be displayed on said display screen, wherein said layout decision section restricts the spacing at the display position on said display screen between the graphic chart on said display screen and the text determined to be relevant to said graphic chart by said document relevance determination section to a prescribed length or less.

3. The image display device according to claim 1, wherein said display timing control section makes the display periods of the text and the graphic chart coincident by making almost coincident the display start and display end timings of the predetermined text and the graphic chart determined to be relevant to said text by said document relevance determination section, if the text or graphic chart displayed on said display screen is switched.

4. The image display device according to claim 3, wherein said display timing control section displays sequentially a plurality of texts relevant to one graphic chart, while said one graphic chart is being displayed, if there are the plurality of texts relevant to said one graphic chart, and displays sequentially a plurality of graphic charts relevant to one text, while said one text is being displayed, if there are the plurality of graphic charts relevant to said one text.

5. The image display device according to claim 2, further comprising a switching operation section for making an operation of switching the graphic chart or the text to be displayed on said display screen.

6. The image display device according to claim 1, wherein there are a plurality of said display screens, the graphic chart and the text being displayed on different display screens, and said display timing control section adjusts the display timing of the graphic chart and the text displayed on said different display screens.

7. The image display device according to claim 6, further comprising a display destination decision section, having the characteristic data concerning the characteristics of said plurality of display screens, for deciding the display screen that is a display destination of the graphic chart and the text based on said characteristic data.

8. An image display device for displaying an image representing a document on a first display screen, said image display device having at least said first display screen, comprising:
a display device connection section for connecting another display device having at least a second display screen to a self device;
a connection determination section for determining whether or not another display device is connected by said display device connection section;
a display destination decision section for selecting one of said first display screen and said second display screen as the display screen for displaying the graphic chart contained in said document, and selecting the other display screen as the display screen for displaying the text contained in said document, if it is determined that another display device is connected by said connection determination section; and
an image display section for displaying the text and the graphic chart contained in said document on each of said first display screen and said second display screen selected by said display destination decision section.

9. The image display device according to claim 8, further comprising a document relevance determination section for determining the relevance between the text and the graphic chart contained in the document by analyzing said document, and
a display timing control section for displaying, based on a display state of the predetermined graphic chart or text on said first display screen, the graphic chart or text determined to be relevant to the predetermined graphic chart or text by said document relevance determination section on said second display screen.

10. The image display device according to claim 9, wherein if it is determined that another display device is not connected by said connection determination section, said display destination decision section decides the display screen for displaying the graphic chart and the text contained in said document as said first display screen, said image display section displays the graphic chart and the text on the first display screen, and said display timing control section displays the graphic chart determined to be relevant to said text by said document relevance determination section on said first display screen, while the predetermined text is being displayed on said first display screen.

11. A display system for displaying a document containing a text and a graphic chart, comprising:
a plurality of display screens; and
a display control device for controlling the display timing of an image displayed on each of the plurality of display screens;
wherein said display control device comprises:
a document relevance determination section for determining the relevance between the graphic chart and the text contained in the document by analyzing said document; and
a display timing control section for controlling the display start and end on said display screen for the graphic chart displayed on any of said display screens, based on a display state on other display screens for the text that is determined to be relevant to said graphic chart by said document relevance determination section.

12. An image display system comprising:
a first display device having at least a first display screen; and
a second display device having at least a second display screen and connected to said first display device,
wherein said first display device comprises:
a display destination decision section for selecting one of said first display screen and said second display screen as the display screen for displaying the graphic chart contained in said document to be displayed, and selecting the other display screen as the display screen for displaying the text contained in said document;
a document relevance determination section for determining the relevance between the graphic chart or text displayed on said first display screen selected by said display destination decision means and the graphic chart or text displayed on said second display screen by analyzing said document; and
a display timing control section for displaying the graphic chart or text determined to be relevant to said graphic chart or text by said document relevance determination section on said second display screen, based on a display state of the predetermined graphic chart or text on said first display screen.

13. A program for executing an image displaying method by a computer for use in an image display device having at least a first display screen for displaying the image representing a document on said first display screen, said program comprising:
a connection determination step of determining whether or not another display device having at least a second display screen is connected;
a display destination decision step of selecting one of said first display screen and said second display screen as the display screen for displaying the graphic chart contained in said document to be displayed, and selecting the other display screen as the display screen for displaying the text contained in said document, if it is determined that another display device is connected at said connection determination step;
a document relevance determination step of determining the relevance between the graphic chart or text displayed on said first display screen and the graphic chart or text displayed on said second display screen by analyzing said document; and
a display timing control step of displaying the graphic chart or text determined to be relevant to said graphic chart or text by said document relevance determination section on said second display screen, based on a display state of the predetermined graphic chart or text on said first display screen.
